(19) United States
(12) Patent Application Publication
(10) Pub. No.: US 2003/0030658 A1
(43) Pub. Date: Feb. 13, 2003

(54) System and method for mixed reality broadcast

(76) Inventors: Simon Gibbs, San Jose, CA (US); Michael Hoch, San Jose, CA (US); Hubert Le Van Gong, Santa Clara, CA (US); Richter A. Rafey, Santa Clara, CA (US); Sidney Wang, Pleasanton, CA (US)

Correspondence Address: Richard H. Butt, Valley Oak Law, 5655 Silver Creek Valley Road, #106, San Jose, CA, 95138, US

(21) Appl. No.: 10/215,983

(22) Filed: Aug. 8, 2002

Related U.S. Application Data
(60) Provisional application No. 60/311,477, filed on Aug. 10, 2001.

(51) Int. Cl. G09G 5/00

(52) U.S. Cl. 345/700

(57) ABSTRACT

The invention illustrates a system and method of simultaneously displaying a virtual scene and a real scene comprising: sensing an instrumentation data stream from a sensor; capturing a video stream of a real event from a camera; and rendering a virtual image including a display area for displaying the video stream wherein the display area is positioned in response to the instrumentation data stream.

### CROSS REFERENCE TO RELATED APPLICATIONS

The application claims relating from the U.S. provisional application entitled “Method and Apparatus for Mixed Reality Broadcast” filed on Aug. 10, 2001, with serial number 60/311,477, which is herein incorporated by reference.

### FIELD OF THE INVENTION

The invention relates generally to audio/visual content and more particularly to an apparatus and method for improved real and virtual images.

### BACKGROUND OF THE INVENTION

In many applications, virtual reality is the simulation of a real environment. Utilizing virtual reality may be useful for television productions due to a desire for re-creating and replaying various scenes of live events.

Various popular products are available in the marketplace for creating virtual reality effects on personal computers. However, they are limited in creating virtual reality based on real events.

When creating a simulated environment associated with a real event, various physical data may be collected to increase the realism of the simulated environment. For example, a virtual simulation may model a real event such as auto racing. In order to create a virtual race track with virtual race cars, knowing the physical parameters associated with real race cars racing on a real race track may be helpful.

Typical television sport event coverage includes many video cameras covering different parts of the event. Some auto racing events have as many as 20 video cameras covering the race track and are capable of providing a viewpoint from many different directions.

To produce a television program of a live event such as auto racing, a large amount of manual input is typically required to create a television program displaying real scenes captured by one of the real cameras and virtual scenes rendered by a processor.

### SUMMARY OF THE INVENTION

The invention illustrates a system and method of simultaneously displaying a virtual scene and a real scene comprising: sensing an instrumentation data stream from a sensor; capturing a video stream of a real event from a camera; and rendering a virtual image including a display area for displaying the video stream wherein the display area is positioned in response to the instrumentation data stream.

Other aspects and advantages of the invention will become apparent from the following detailed description, taken in conjunction with the accompanying drawings, illustrated by way of example of the principles of the invention.

### BRIEF DESCRIPTION OF THE DRAWINGS

FIG. 1 illustrates one embodiment of a system overview according to the invention.

FIG. 2 illustrates one embodiment of a system overview according to the invention.

FIG. 3 illustrates an exemplary block diagram of the system according to the invention.

FIG. 4 illustrates an exemplary process flow diagram according to the invention.

FIGS. 5-8 show an exemplary screen shot illustrating one embodiment according to the invention.

### DETAILED DESCRIPTION

Specific reference is made in detail to the embodiments of the invention, examples of which are illustrated in the accompanying drawings. While the invention is described in conjunction with the embodiments, it will be understood that the embodiments are not intended to limit the scope of the invention. The various embodiments are intended to illustrate the invention in different applications. Further, specific details are set forth in the embodiments for exemplary purposes and are not intended to limit the scope of the invention. In other instances, well-known methods, procedures, and components have not been described in detail as not to unnecessarily obscure aspects of the invention.

The invention includes a system and method for generating a virtual mode viewing environment. The invention utilizes techniques for integrating a simultaneous display of both a virtual image and a real image in response to the instrumentation data gathered by video cameras and/or sensors. For the sake of simplicity and clarity, the invention is described with MPEG-2 being chosen as the delivery mechanism. However, any delivery mechanism suitable for use with the invention may be utilized.

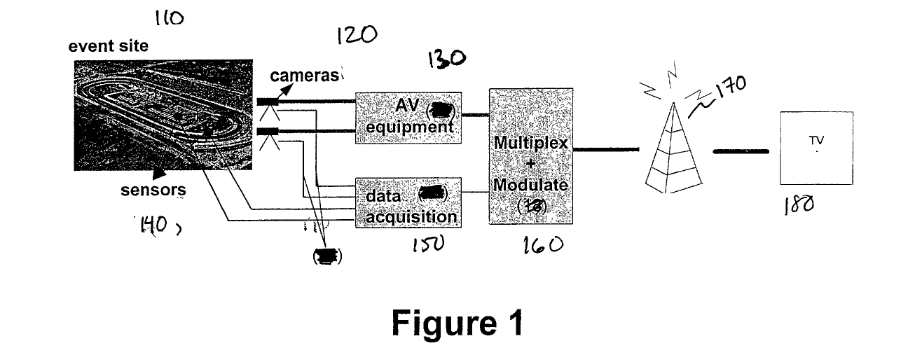

FIG. 1 illustrates a schematic diagram of one embodiment of a data acquisition and transmission system for use with a digital television system. In this illustrated example, an event occurs at an event site 110. In one embodiment, the event at the event site 110 is an auto racing event. However, any live event such as a sports event, a concert, a theatrical event, and the like may be utilized.

A plurality of cameras 120 is utilized to capture visual and audio signals of the event at the event site 110. In addition, the plurality of cameras 120 also captures camera instrumentation data concurrently with the visual and audio signals. Camera instrumentation data may include, for each video frame, the camera location, tilt, zoom, pan, field of view, focus setting, iris setting, and other information related to the optics of each of the plurality of cameras 120.

A plurality of sensors 140 are utilized within the event site 110 to capture performance instrumentation data. The performance instrumentation data describes the real event at the event site 110. The plurality of sensors 140 may capture the performance instrumentation data concurrently with the data camera instrumentation data captured by the plurality of cameras 120. In this example of a car racing event, each racecar may utilize a global positioning satellite unit as one of the plurality of sensors 140 to provide the performance instrumentation data in the form of the position related to the racecar. In another embodiment, one of the plurality of sensors 140 may include force sensor within each racecar provide the performance instrumentation data in the form of the force exerted on the racecar. These specific examples of the plurality of sensors 140 are shown for exemplary purposes only. Any type of sensor used to measure a physical aspect of the event at the event site 110 may be utilized.

An audio/visual equipment module 130 is configured to process the audio visual signals. In one embodiment, the audio/visual equipment module 130 is configured to receive the audio/visual signals from the plurality of cameras 120.

A data acquisition module 150 is configured to process instrumentation data. In one embodiment, the data acquisition module 150 is configured to receive the camera instrumentation data from the plurality of cameras 120 and the performance instrumentation data from the plurality of sensors 140. Thus, the performance data collected in the data acquisition module 150 includes both the camera instrumentation data which relates to particular parameters associated with the plurality of cameras 120 while recording the event and the performance instrumentation data which relates to data captured by the plurality of sensors 140 which describes aspects of the event.

The multiplex and modulate module 160 is configured to receive the audio visual signals from the audio visual equipment module 130 and the instrumentation data from the data acquisition module 150. In one embodiment, the module 160 is configured to multiplex and modulate the audio visual signals with the instrumentation data into a unified signal relative to time. A transmitter module 170 is configured to receive the unified signal from the multiplex and modulate module 160 and to transmit this unified signal. A television 180 a shown as an exemplary device to receive the unified signal via the transmitter module 170.

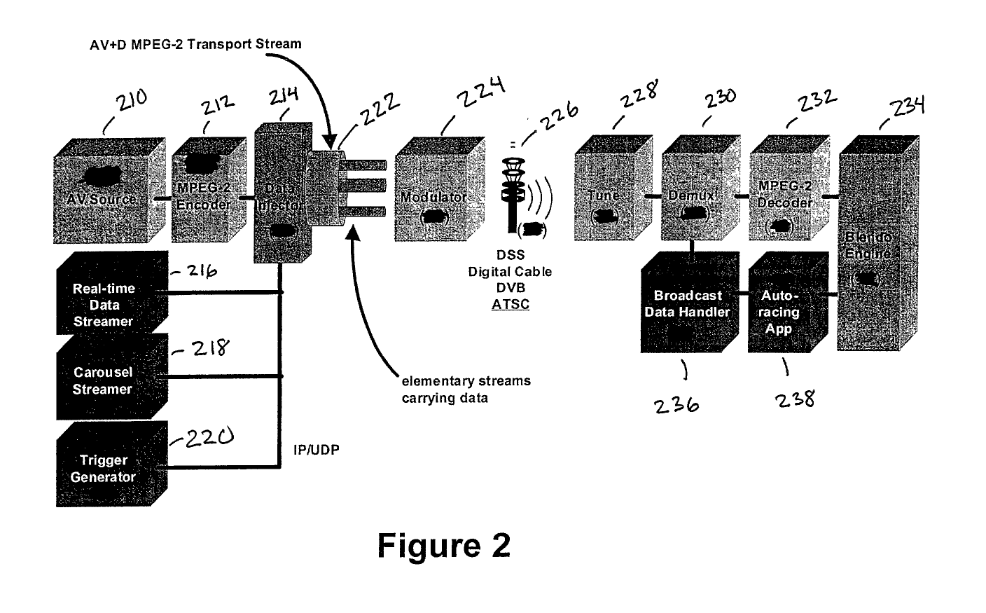

With reference to FIG. 2, a system 200 is shown for acquiring and processing both audio and video signals of an event and corresponding instrumentation data which describes physical parameters of the event according to one embodiment of the invention. In one example within the context of auto racing, the instrumentation data may include car speed, engine performance, physical location of the car, forces applied to the car, and the like. In other embodiments, the instrumentation data will vary with the specific application of the invention.

The instrumentation data corresponds with the audio and video signals in real time; the instrumentation data and the audio and video signals are temporally correlated. In one embodiment, they are temporally correlated by the use of timestamps. In another embodiment, they may be temporally correlated by relative signal timing.

In one embodiment, the system 200 includes an audio/visual (AN) source 210, an MPEG-2 encoder 212, a data injector 214, a real-time data streamer 216, a carousel streamer 218, a trigger generator 220, an AV and data transport stream 222, a modulator 224, a transmitter 226, a tuner 228, a demultiplexer 230, an MPEG-2 decoder 232, a presentation engine 234, a broadcast data handler 236, and an application module 238. Additional specific elements common in computer system such as processors, memory, user interfaces, system busses, storage devices, and the like are not shown to prevent unnecessarily obscuring the aspects of the invention.

The components 210-238 are merely illustrated in FIG. 2 as one embodiment of the system 200. Although the components 210-238 are illustrated in FIG. 2 as separate components of the system 200, two or more of these components may be integrated, thus decreasing the number of components in the system 200. Similarly, the components 210-238 may also be separated, thus increasing the number of components within the system 200. Further, the components 210-238 may be implemented in any combination of hardware, firmware and software.

The AN source 210 is connected to the MPEG-2 encoder 212 and provides the MPEG-2 encoder with AV content. In one embodiment, the AN source 210 includes a video camera. However, in another embodiment, the AN source 210 may also include a video cassette recorder, a digital recorder, or other means for providing AN content. The MPEG-2 encoder 212 receives the A/V content and encodes this content to form an encoded AN data stream according the MPEG-2 standard which is well known in the art. In other embodiments, other AN encoders such as MPEG-1 or MPEG-4 may be utilized.

The MPEG-2 encoder 212, the real-time data streamer 216, the carousel streamer 218 and the trigger generator 220 are connected to the data injector 214. The real-time data streamer 216 provides the data injector 214 with instrumentation data which describes and corresponds in real-time with the A/V content from the AN source 110. Instrumentation data describes in real-time physical aspects or conditions that correspond with the AN content.

The carousel streamer 218 provides the data injector 214 with assets (e.g., images, audio clips, text files) related to the user interface. In one embodiment, the carousel streamer 218 also contains static data related to the real event such as starting race orders, driver statistics, and the like in a race event example. The trigger generator 220 provides the data injector 214 with data used to activated predefined actions on the receiver (e.g., authored questions for a trivia game or poll, advertisement names for pop-up ad inserts).

The data injector 214 receives incoming data from the MPEG-2 encoder 212, the real-time data streamer 216, the carousel streamer 218, and the trigger generator 220. The data injector 214 synchronizes the incoming data such that the data from the real-time data streamer 216, carousel streamer 218, and trigger generator 220 are timed with the corresponding encoded AN data stream. The data injector 214 is connected to the AN and data transport stream 222 and feeds the synchronized data through the AN and data transport stream 222 to the modulator 224.

The modulator 224 receives the synchronized data. The synchronized data includes the encoded AN data stream and associated instrumentation data from the real-time data streamer 216, carousel streamer 218, and trigger generator 220. The modulator 224 broadcasts this synchronized data through the transmitter 226. The transmitter 226 may broadcast through air, cable, phone lines, and the like.

The tuner 228 receives the synchronized data which is broadcast through the transmitter 226. The demultiplexer 230 is connected to the tuner 228 and receives the synchronized data from the tuner 228. The demultiplexer 230 separates the encoded AN data stream from other data originally from the realtime data streamer 216, carousel streamer 218, and trigger generator 220. The MPEG-2 decoder 232 is connected to the demultiplexer 230 and receives the encoded AN data stream from the demultiplexer 230. The broadcast data handler 236 is connected to the demultiplexer. The data from the real-time data streamer 216, carousel streamer 218, and trigger generator 220, is received by the broadcast data handler 236 from the demultiplexer 230.

The MPEG-2 decoder processes the encoded AN data stream and returns a decoded AV data stream which is either identical or nearly identical to the original AN data stream from the AN source 210. Similar to the MPEG-2 encoder 212, the MPEG-2 decoder 232 may be substituted with other AN encoders such as MPEG-1 or MPEG-4 . The MPEG-2 decoder 232 is connected with the presentation engine 234. The presentation engine 234 receives the decoded AN data stream from the MPEG-2 decoder 232.

The broadcast data handler 236 is connected to the application module 138. The broadcast data handler 236 reformats the data from the transport stream into data that the application module 238 can utilize. The data from the real-time data streamer 216, carousel streamer 218, and trigger generator 220 is received by the application module 238. The application module 238 utilizes the data from the real-time data streamer 216, carousel streamer 218, and trigger generator 220. The application module 238 also interacts with the presentation engine 234.

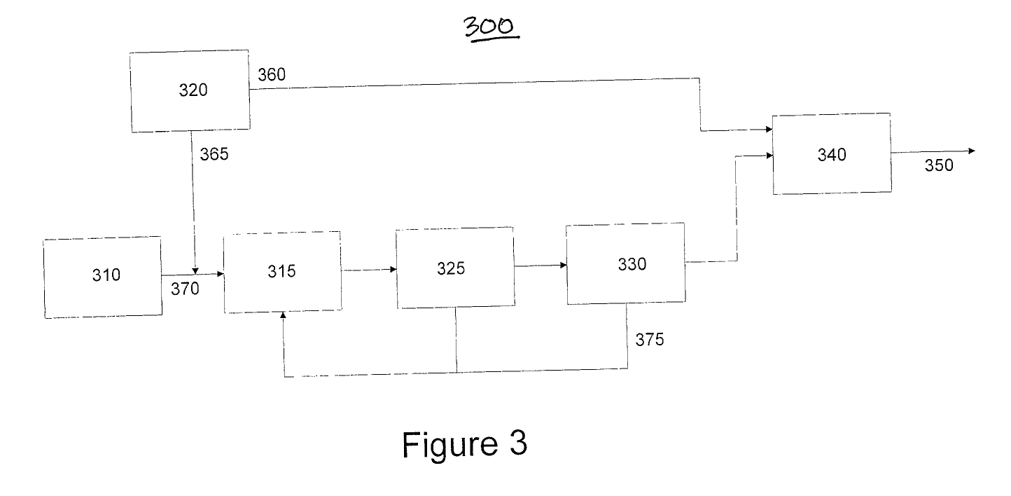

With reference to FIG. 3, a system 300 is shown for acquiring and processing both audio and video signals of an event and corresponding instrumentation data which describes physical parameters of the event and camera parameters according to one embodiment of the invention. The system 300 includes a sensor 310, a world model module 315, a camera 320, a user interface module 325, a rendering module 330, and a compositing module 340.

The components 310-340 are merely illustrated in FIG. 3 as one embodiment of the system 300. Although the components 310-340 are illustrated in FIG. 3 as separate components of the system 300, two or more of these components may be integrated, thus decreasing the number of components in the system 300. Similarly, the components 310-340 may also be separated, thus increasing the number of components within the system 300. Further, the components 310-340 may be implemented in any combination of hardware, firmware and software.

In one embodiment, the sensor 310 and the camera 320 are configured on the broadcast side and the rendering module 330 and the compositing module 340 are configured to be placed on the receiver side. However, in other embodiments, the rendering module 330 and the compositing module 340 are configured to be placed on the broadcast side.

In one embodiment, the camera 320 is configured to capture both image data 360 and camera instrumentation data 365. The image data 360 is sent the compositing module 340. The camera instrumentation data 365 is sent to the rendering module 330. The camera instrumentation data 365 may include field-of-view data, camera position data, zoom data, and pan data of the event being captured by the camera 320. There may also be multiple cameras within the system 300 wherein each camera is uniquely identified. The sensor 310 is configured to capture performance instrumentation data 370 for use by the rendering module 330. In one embodiment, an auto racing event is utilized to demonstrate various performance instrumentation data 370 within the system 300. In other embodiments, the system 300 may be applied to other events. For example, the performance instrumentation data 370 may include car speed, car engine performance parameters, forces exerted onto the car, car position, and the like. Multiple sensors may be utilized within the system 300.

The world model module 315 receives the camera instrumentation data 365 and the performance instrumentation data 370. The world model module 315 is configured to track the locations of objects and cameras within the real event. In one embodiment, the world model module 315 is a scene graph representation of the real event. Within the scene graph representation, the world model module 315 stores both static nodes and dynamic nodes. The static nodes are objects and/or features within the virtual image that represent the real event which do not change over the course of the event. For example, a race track for an auto racing application may be represented by a static node. The dynamic nodes are objects and/or features within the virtual image which may change over the course of the real event. For example, a race car for an auto racing application may be represented by a dynamic node. The camera instrumentation data 365 and the performance instrumentation data 370 serve to update the world model module 315.

The user interface module 325 is configured to receive input from a user. The user interface module 325 modifies the world model module 315 based on the input from the user. For example, the user may add additional objects that are tracked by the world model module 315. These modifications are subsequently transmitted to the world model module 315.

The rendering module 330 receives the camera instrumentation data 365 and the performance instrumentation data 370. In one embodiment, the rendering module 330 generates a virtual image based on the camera instrumentation data 365. In another embodiment, the rendering module 330 generates a virtual image based on the performance instrumentation data 370. In yet another embodiment, the rendering module 330 generates a virtual image based on the camera instrumentation data 365 and the performance instrumentation data 370.

In one embodiment, the rendering module 330 is configured to generate a virtual image that incorporates the inclusion of the image data 360 from the camera 320. Additional examples of the inclusion of the image data 360 within the virtual image are illustrated in the following figures.

The compositing module 340 receives the virtual image from the rendering module 330 and the image data 360 from the camera 320. In one embodiment, the compositing module 340 integrates the image data 360 within the virtual image. In other words, the compositing module 340 blends the image data 360 within the virtual image to create a single, combined virtual image wherein the combined virtual image includes the virtual image from the rendering module 330 combined with the image data 360 which depicts a real event captured by the camera 320.

For the sake of clarity, the embodiment shown in the system 300 is illustrated utilizing the virtual image created by the rendering module 330 and image data representing a single real image captured by the camera 320. In another embodiment, multiple virtual images and image data representing multiple real images may be utilized to create a stream of images representing a video stream. Further, this stream of images both virtual and real may be combined by the compositing module 340.

Auto racing has been utilized as an example within various embodiments of the invention. However, any type of live event is suitable as application for use with the invention. For example, in a televised football game, the static portions of the world model include the football field and surrounding stadium. The dynamic objects include the football players and the ball. If the instrumentation data includes tracking the position of the football players, then the football player positions may be tracked using a technique such as inverse kinematics in one embodiment. If the instrumentation data includes tracking the particular motions of the football players, then the football player motions may be tracked using a technique such as joint position and/or orientation in one embodiment.

The world model module 315, the user interface module 325, and the rendering module 330 operate to effectively and smoothly display both a virtual image rendered by the rendering module 325 and a real image captured by the camera 320 and vice-versa. For example, the world model module 330 is constantly being updated by incoming instrumentation data. This updating may include parameters such as camera positions, camera zooms, object positions, object deformation, object rotation, and the like. Additional parameters may be utilized. In one embodiment, the world model module 315 also tracks the parameters associated with a virtual camera. The virtual camera represents the view for the virtual image.

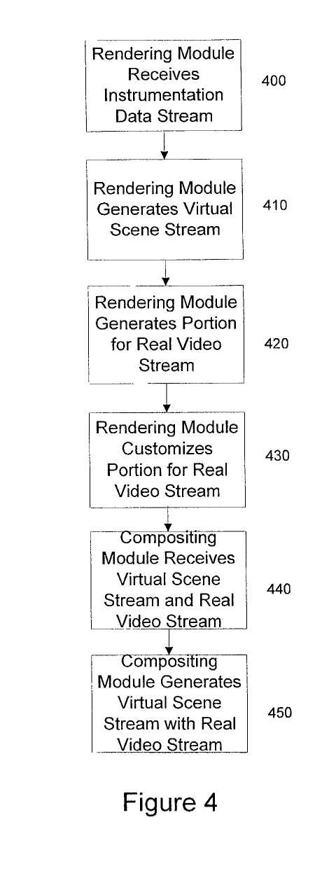

The flow diagram as depicted in FIG. 4 is merely one embodiment of the invention. In this embodiment, the flow diagram illustrates the use of the instrumentation data within the system 300 (FIG. 3).

The blocks within the flow diagram may be performed in a different sequence without departing from the spirit of the invention. Further, blocks may be deleted, added or combined without departing from the spirit of the invention.

In Block 400, the instrumentation data is received by the rendering module 330 (FIG. 3). The instrumentation data may include both camera instrumentation data and performance instrumentation data.

In Block 410, the rendering module 330 generates a virtual scene data stream. The virtual scene data stream represents a virtual video stream which is comprised of a series of virtual images. In one embodiment, the virtual scene data stream is generated in response to the instrumentation data. In another embodiment, the virtual scene data stream is generated in response to meta-tag labels associated with the instrumentation data. In yet another embodiment, the virtual scene data stream is generated in response to the real images associated with the instrumentation data.

In Block 420, the rendering module 330 allocates a portion of the virtual image within the virtual video stream for a real image. In one embodiment, the real image is inset within the virtual image. In another embodiment, the virtual image is inset within the real image. The real image is an image captured at a live event.

In Block 430, the rendering module 330 customizes the portion of the virtual image reserved for the real image. The orientation of the real image being shown simultaneously with the virtual image is dependent on the instrumentation data. For example, the real image is displayed on a plane surface within a virtual image in one embodiment. In this example, the location of the plan surface within the virtual image is dependent on the camera instrumentation such as field-of-view, camera location, zoom, and/or pan data. In another embodiment, the three dimensional orientation of the plane surface relative to the viewer is manipulated in response to the instrumentation data. In other embodiment, the real image is not restricted to being displayed on the plane surface and may be displayed on a variety of surfaces and/or contours.

In one embodiment, the rendering module 330 customizes the orientation of the image in response to the instrumentation data. In another embodiment, the rendering module 330 customizes the virtual image in response to the instrumentation data. In yet another embodiment, the rendering module 330 customizes both the virtual image and the orientation of the real image in response to the instrumentation data.

In Block 440, the compositing module 340 (FIG. 3) receives the virtual scene data stream from the rendering module 330 and the real video stream from a video source. In Block 450, the compositing module 340 integrates the virtual scene data stream and the real video stream in response to the allocation and customization processes shown for exemplary purposes within the rendering module 330.

The Blocks 400-450 are being performed within the context of the rendering module 330 and the compositing module 340 for exemplary purposes only. In other embodiments, the Blocks 400-450 may be performed in any generalized processor or any graphics specific processor.

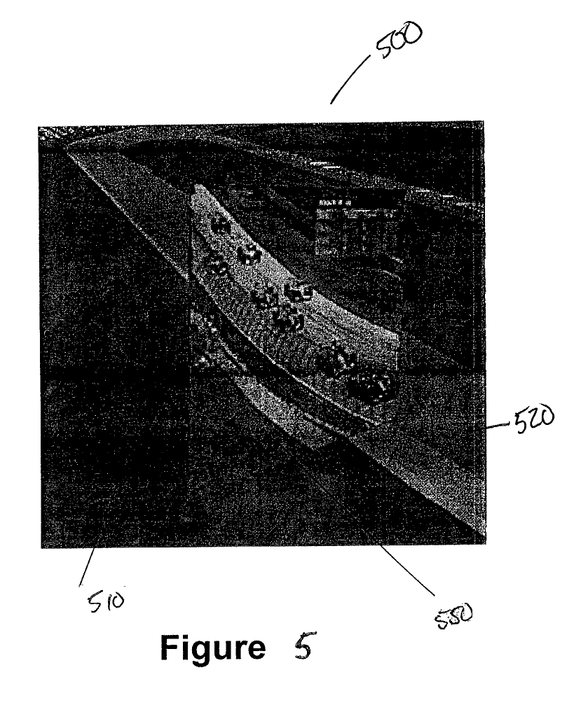

For the sake of clarity, FIGS. 5-8 illustrate a particular screen shot for demonstrating one embodiment for the invention. Other embodiments may contain variations of the particular screen shots shown in FIGS. 5-9 without departing from the spirit of the invention. In the screen shots, an auto racing application is utilized. However, any live event may be utilized in other embodiments.

FIG. 5 illustrates a screen shot 500. The screen shot 500 includes a virtual scene image 510 and a real scene image 550. Although possibly based on a real event, the virtual scene image 510 is a rendered image and is not captured from a live event. In one embodiment, the virtual scene image 510 is a single virtual image within a series of virtual images. The real scene 550 is captured from a live event and is one real image within a series of real images.

The virtual scene image 510 includes a virtual race track 520. The real scene image 550 is displayed on a surface. In one embodiment, the surface of the real scene image 550 is displayed at a particular angle such that the real scene image 550 is presented to have a three dimensional quality even though the real video image as captured by a video source in two dimensions. In one embodiment, the angle of the real scene image 550 as displayed within the screen shot 500 is in response to the instrumentation data from the camera such as field-of-view and/or camera position.

In one embodiment, the real scene image 550 is positioned relative to the virtual race track 520 in response to the actual location of the real race cars which are the subjects of the real scene image 550. The real scene image 550 may be positioned relative to the virtual race track 520 in response to the instrumentation data from the location of the race cars, the field-of-view by the camera, and/or the position of the camera.

In one embodiment, the virtual race track 520 may be appropriately sized relative to the real scene image 550 in response to the instrumentation data such as the zoom of the camera. In another embodiment, the real scene image 550 may be appropriately sized relative to the virtual scene image 510 in response to the instrumentation data such as the zoom of the camera.

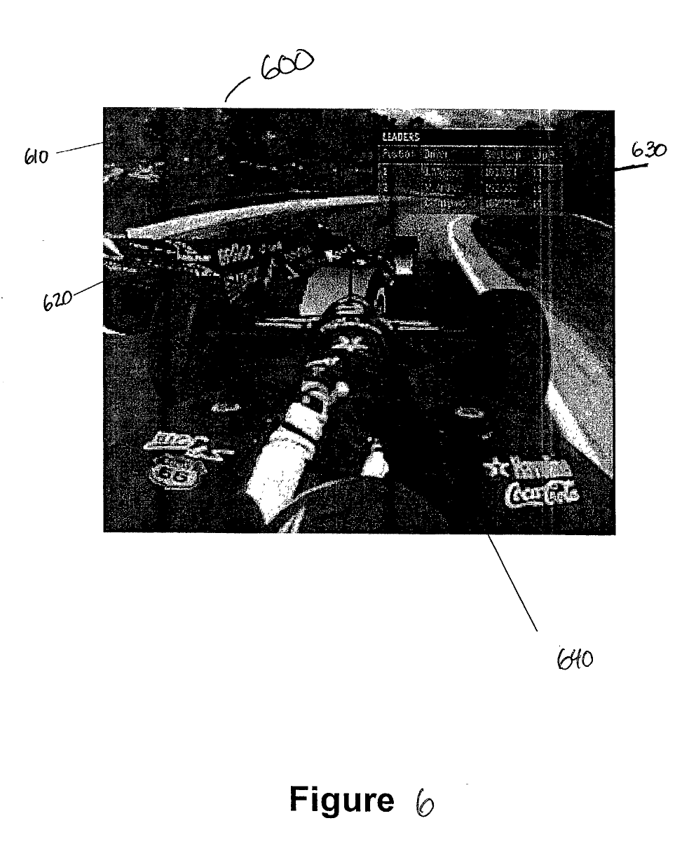

FIG. 6 illustrates a screen shot 600. The screen shot 600 includes a real background image 610, a virtual race car 620, a virtual scoreboard 630, and a real race car 640. The real background image 610 and the real race car 640 are captured by a camera. The virtual race car 620 and the virtual scoreboard 630 are digitally rendered. In one embodiment, the virtual race car 620 and the virtual scoreboard 630 are sized and positioned in response to the instrumentation data such as the location of the real race car 640, the position of the camera, the zoom of the camera, and/or the field-of-view of the camera.

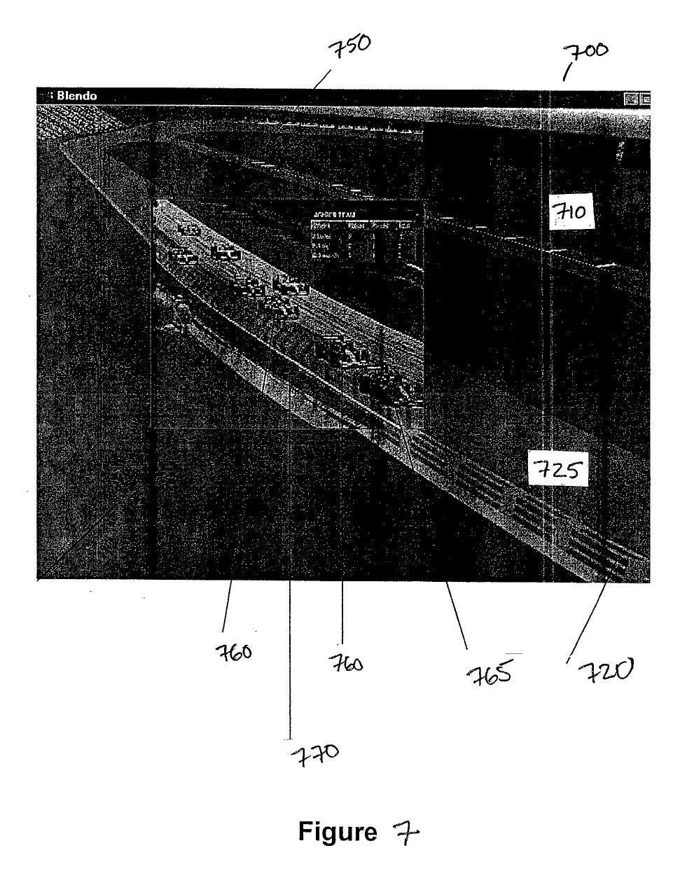

FIG. 7 illustrates a screen shot 700. The screen shot 700 includes a virtual scene image 710 and a real scene image 750. Although possibly based on a real event, the virtual scene image 710 is a rendered image and is not captured from a live event. In one embodiment, the virtual scene image 710 is a single virtual image within a series of virtual images. The real scene 750 is captured by a camera from a live event and is one real image within a series of real images.

The real scene image 750 includes a plurality of race cars 760 and a guard rail 770. The virtual scene image 710 includes a virtual guard rail 720 and a virtual race track 725.

In one embodiment, the real scene image 750 is positioned within the virtual scene image 710 such that the guard rail 770 is aligned with the virtual guard rail 720. The real scene image 750 is positioned within the virtual scene image 710 in response to the instrumentation data such as the zoom of the camera, the location of the camera, the pan/tilt of the camera, the field-of-view of the camera, and/or the location of the guard rail 765.

In one embodiment, the angle of the real scene image 750 relative to the screen shot 700 is determined based on the location of the camera, the pan/tilt of the camera, and/or the field-of-view of the camera. In one embodiment, the angle of the real scene image 750 corresponds with the perspective angle of the camera when capturing the real scene image. This angle of the real scene image 750 delivers additional information and perspective to a viewer of the screen shot 700.

In one embodiment, the location of the plurality of real race cars 760 are tracked within the real scene image 750. Their locations within the real scene image 750 may be tracked via instrumentation data such as the zoom of the camera, the location of the camera, the pan/tilt of the camera, the field-of-view of the camera, and/or the location of the plurality of real race cars 760. In one embodiment, as a real race car 765 moves towards the edge of the real scene image 750, the virtual scene image 710 may be rendered with a virtual race car on the virtual race track 725 representing the real race car 765.

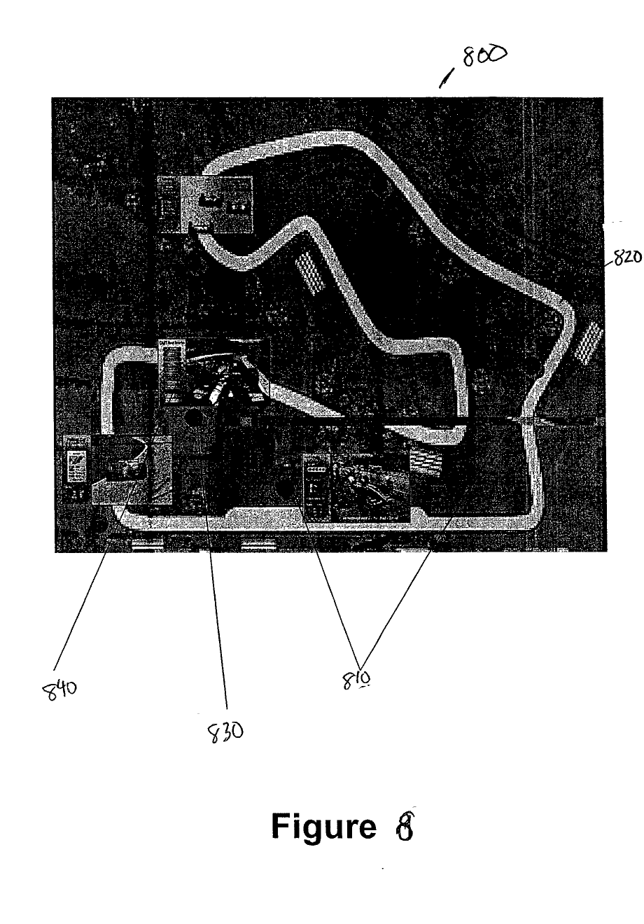

FIG. 8 includes a screen shot 800 which illustrates an overview mode. This overview mode shows the positions of multiple cameras and their corresponding video feeds. Each camera is represented by one of a plurality of dots 810 within the screen shot 800. The position of each of the plurality of dots 810 relative to a virtual race track 820 correlates to the position of the camera within a real race track. The position of each of the cameras may be determined through the camera instrumentation data.

A dot 830 which represents a particular camera corresponds with a video feed 840 which shows a stream of real images captured by the particular camera. The video feeds displayed adjacent to a corresponding dot accurately reflects the viewpoint of each corresponding camera. In another embodiment, the video feed rotates on an axis as the viewpoint of the camera changes. The changing viewpoint of the camera may be identified by the camera instrumentation data and the performance instrumentation data. As a result, the screen shot 800 is capable of showing tracked cameras in a virtual scene and conveying three dimensional movement using a two dimensional image.

The foregoing descriptions of specific embodiments of the invention have been presented for purposes of illustration and description. For example, the invention is described within the context of auto racing and football as merely embodiments of the invention. The invention may be applied to a variety of other theatrical, musical, game show, reality show, and sports productions.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

In the claims:

1. A system comprising:
a. a sensing device for generating an instrumentation data stream;
b. a camera device for capturing a real video stream; and
c. a rendering module configured for receiving the instrumentation data stream, rendering a virtual image, and allocating a portion of the virtual image for displaying the real video stream wherein the real video stream is oriented within the virtual image in response to the instrumentation data stream.

2. The system according to claim 1 wherein the sensing device is a sensor for measuring a physical parameter associated with a real event.

3. The system according to claim 1 wherein the physical parameter may include a location.

4. The system according to claim 1 wherein the sensing device is incorporated within the camera device for measuring a parameter of the camera device.

5. The system according to claim 1 further comprising a compositing module configured for integrating the real video stream within the virtual image wherein the virtual image and the real video stream are simultaneously displayed.

6. The system according to claim 1 wherein the portion of the virtual image for displaying the real video stream is a surface plane.

7. The system according to claim 6 wherein the surface plane is positioned within the virtual image in response to the instrumentation data stream.

8. The system according to claim 6 wherein the surface plane is rotated relative to the virtual image in response to the instrumentation data stream.

9. The system according to claim 1 wherein the instrumentation data includes one of a camera position, a camera zoom, a camera pan, a camera tilt, a camera field-of-view, and an object location.

10. A method comprising:
a. sensing an instrumentation data stream from a sensor;
b. capturing a video stream of a real event from a camera; and
c. rendering a virtual image including a display area for displaying the video stream wherein the display area is positioned in response to the instrumentation data stream.

11. The method according to claim 10 wherein the instrumentation data includes one of a camera position, a camera zoom, a camera pan, a camera tilt, a camera field-of-view, and an object location.

12. The method according to claim 10 further comprising integrating the virtual image and the video stream into a display image wherein the display image includes a simultaneous display of the virtual image and the video stream.

13. The method according to claim 10 further comprising designating a surface plane as the display area for the video stream.

14. The method according to claim 13 further comprising tilting the surface plane in response to the instrumentation data wherein an angle of the surface plane represents a perspective of the camera capturing the video stream.

15. The method according to claim 10 further comprising matching a virtual position of a virtual object in the virtual image with a real position of a real object within the video stream wherein the real position corresponds with the instrumentation data stream.

16. The method according to claim 15 further comprising positioning the display area relative to the virtual image in response to matching the virtual position with the real position.

17. A computer-readable medium having computer executable instructions for performing a method comprising:
a. sensing an instrumentation data stream from a sensor;
b. capturing a video stream of a real event from a camera; and
c. rendering a virtual image including a display area for displaying the video stream wherein the display area is positioned in response to the instrumentation data stream.
